(19) United States
(12) Patent Application Publication
(10) Pub. No.: US 2002/0001764 A1
(43) Pub. Date: Jan. 3, 2002

(54) Method and device for analyzing structures of a photomask

(76) Inventors: Guenther Ruhl, Dorfen (DE); Martin Verbeek, Munchen (DE); Thomas Struck, Olching (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/891,189

(22) Filed: Jun. 25, 2001

(30) Foreign Application Priority Data
Jun. 23, 2000 (DE) 100 30 695.0

(51) Int. Cl. G03C 5/00; G06K 9/00

(52) U.S. Cl. 430/30; 382/145

(57) ABSTRACT

A method and a device for analyzing structures of a photomask are described. In a first method step, at least one trench is created in the photomask, so that at least one lateral limitation of the trench forms a section through the structures to be analyzed. Then, the structures to be analyzed are scanned by scanning beams, which are guided through the trench on its lateral limitation.

### BACKGROUND OF THE INVENTION

### Field of the Invention

The invention relates to a method and a device for analyzing structures of a photomask.

Photomasks of this type are used in particular for carrying out photolithographic processes in the production of integrated circuits in semiconductor substrates.

The semiconductor substrates are formed as wafers to which photosensitive resist layers are applied and are exposed variously for creating circuit structures in different regions. The exposure patterns are defined by photomasks that are disposed over the resist layer and are disposed in the path of rays of a source of illumination.

The photomasks are formed for example as chromium masks, halftone phase masks or alternating phase masks. The photomasks in this case typically have a basic body of quartz glass, into which structures in the form of trench-shaped recesses are worked, according to the distinctive form of the photomask. Moreover, absorber films are applied to the surface of the photomasks in predetermined patterns.

To ensure flawless functioning of the photomasks, the structures must be examined.

For this purpose, some of the photomasks produced in the production process are taken as samples during a testing procedure and are broken. At the place where they break, the structures of the photomasks are examined, preferably microscopically. A disadvantage of this is that the samples are destroyed during the testing procedure, and consequently can no longer be used any further. Consequently, testing of this type produces an undesirably high amount of wastage in the production of photomasks.

Alternatively, the surfaces of the photomasks are measured in reflected-light processes, for example by use of a microscope, and assessed on the basis of these data. A disadvantage of these testing methods is that they only allow the quality of the surfaces of the samples to be assessed. Nothing can be ascertained however concerning the cross-sectional geometries of the structures.

### SUMMARY OF THE INVENTION

It is accordingly an object of the invention to provide a method and a device for analyzing structures of a photomask which overcome the above-mentioned disadvantages of the prior art methods and devices of this general type, which provides for a simple, complete and nondestructive analysis of structures of photomasks.

With the foregoing and other objects in view there is provided, in accordance with the invention, a method for analyzing parts of a mask. The method includes the steps of providing a photomask; creating a trench having at least one lateral limitation in the photomask such that the lateral limitation of the trench forms a section through structures of the photomask to be analyzed; and scanning the structures to be analyzed using scanning beams guided through the trench onto the lateral limitation.

According to the invention, at least one trench is created in the photomask to be investigated, so that at least one lateral limitation of the trench forms a section through the structures of the photomask to be analyzed. The structures are then scanned by scanning beams, the scanning beams being guided through the trench on its lateral limitation.

As a result, not only surface structures but also cross-sectional structures of the photomask can be examined in a simple and reliable manner. It is particularly advantageous here that the photomask does not need to be broken for examination to be carried out, so that they can be used further after the testing producer.

The trenchs are applied particularly advantageously at predetermined reference positions of the photomask, which are not required for the functioning of the photomask. This ensures that, once testing has taken place, the photomask can be used unrestrictedly for carrying out a photolithographic process.

The trenches are preferably created by a focused ion beam, in each case to a suitable depth and width, so that the entire structure to be analyzed of the photomask can be sensed by the scanning beam.

The scanning expediently takes place by a scanning electron microscope. For the alignment of the scanning beams with respect to the structure to be analyzed, the photomask is preferably mounted onto a positionally adjustable sample table, it being possible in particular to set the inclination of the sample table in relation to the beam axis of the scanning beams. This allows the photomask to be aligned in such a way that the entire structures to be analyzed are scanned by the scanning beams.

In accordance with an added mode of the invention, there is the step of etching the photomask for forming the trench.

In accordance with an additional mode of the invention, there is the step of using a focused ion beam during the etching step.

In accordance with another mode of the invention, there is the step of creating the trench with a depth of up to 1 μm using a focused ion beam.

In accordance with a further mode of the invention, there is the step of creating the trench with a width in a range of 0.5 μm to 2 μm using the focused ion beam.

In accordance with another added mode of the invention, there is the step of fixing the photomask to a sample table and aligning the photomask by a positional adjustment of the sample table with respect to the scanning beams after the step of creating the trench in the photomask.

In accordance with another additional mode of the invention, there is the step of adjusting an inclination of the sample table for aligning the photomask with respect to the scanning beams.

In accordance with another further mode of the invention, there is the step of setting an angle of inclination of a surface of the sample table in relation to a beam axis of the scanning beams to approximately 45°.

In accordance with an added mode of the invention, there is the step of forming the lateral limitation of a sectional face to run transversely in relation to the structures to be analyzed.

In accordance with an additional mode of the invention, there is the step of forming the structures to be analyzed as trench-shaped recesses etched out of a surface of the photomask.

In accordance with another mode of the invention, there is the step of providing the photomask as a basic body containing quartz glass.

In accordance with a further mode of the invention, there is the step of applying absorber films to a surface of the quartz glass.

With the foregoing and other objects in view there is further provided, in accordance with the invention, a device containing first means for creating at least one trench in a photomask. The trench has at least one lateral limitation forming a section through structures to be analyzed. A second means is provided for scanning the structures to be analyzed. The second means for scanning emits scanning beams guided through the trench onto the lateral limitation.

In accordance with an added feature of the invention, there is a third means for aligning the trench of the photomask with respect to a beam direction of the scanning beams.

In accordance with an additional feature of the invention, the first means for creating the trench in the photomask includes an ion beam device outputting a focused ion beam.

In accordance with another feature of the invention, the second means for scanning the structures to be analyzed includes a scanning electron microscope.

In accordance with a concomitant feature of the invention, the third means for aligning the trench of the photomask includes a positionally adjustable sample table on which the photomask can be fixed.

Other features which are considered as characteristic for the invention are set forth in the appended claims.

Although the invention is illustrated and described herein as embodied in a method and a device for analyzing structures of a photomask, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1a is a diagrammatic, plan view of a detail of a photomask formed as an alternating phase mask according to the invention;

FIG. 1b is a cross-sectional view through the photomask shown in FIG. 1a;

FIG. 2 is a perspective view of a trench in the photomask shown in FIGS. 1a and 1b for carrying out a structural analysis; and

FIG. 3 is a side-elevational view of a device for carrying out the structural analysis on the photomask.

### DESCRIPTION OF THE PREFERRED EMBODIMENTS

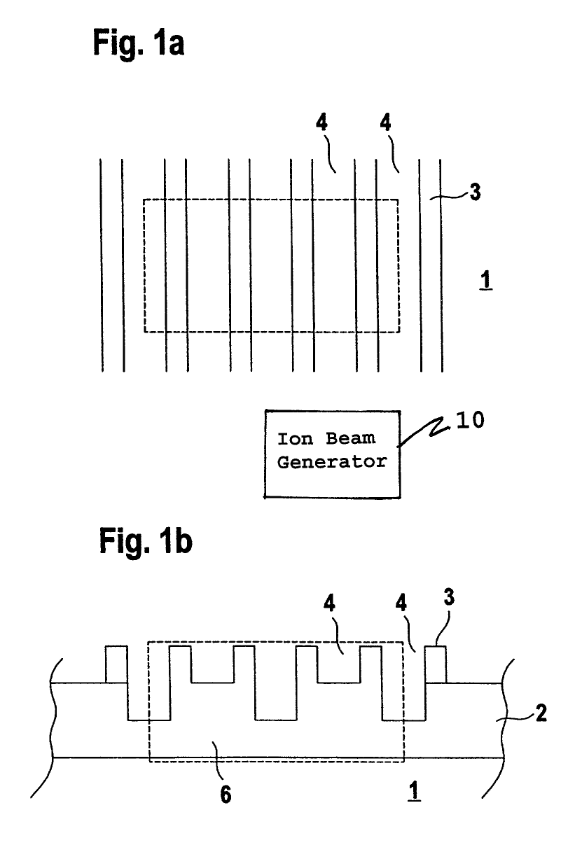

In all the figures of the drawing, sub-features and integral parts that correspond to one another bear the same reference symbol in each case. Referring now to the figures of the drawing in detail and first, particularly, to FIGS. 1a and 1b thereof, there is shown a detail of a photomask 1 which is schematically represented. In the present exemplary embodiment, the photomask 1 is formed as an alternating phase mask. Photomasks 1 of this type are used for the exposure of photosensitive resist layers. The resist layers are applied to a wafer for creating circuit structures. In the process, defined regions of the resist layer are exposed in a predetermined way to correspond to the structures of the phase mask.

The photomask 1, and in particular the alternating phase mask represented in FIGS. 1a and 1b, contains a basic body 2 of quartz glass. A surface of the basic body 2 is coated with an absorber film 3.

Trench-shaped recesses 4, running parallel to one another and in each case along a straight line, have been worked into the basic body 2 and open out at the surface of the alternating phase mask 1. In this case, the recesses 4 have two different depths and are provided alternately at regular intervals. Lands with the absorber films 3 still on their upper side remain between two neighboring recesses 4, while the absorber films 3 have been removed in the recesses 4.

According to the invention, not only the surface structure of the photomask 1 but also cross-sectional structures of the photomask 1 can be reliably examined without the photomask 1 having to be destroyed to do so.

For this purpose, in a first method step further trenches 5 are worked at predetermined reference positions of the photomask 1, the reference positions are at points not required for the functioning of the photomask 1. The working of the further trenches 5 consequently does not reduce the functional capability of the photomask 1.

In principle, a plurality of the further trenches 5 may be worked at the predetermined reference positions in the photomask 1. In the present exemplary embodiment, only one further trench 5 of this type is represented.

It is important when forming the further trench 5 of this type that a lateral limitation or edge 6 of the further trench 5 forms a section through structures to be analyzed. In this case, the structures to be analyzed are the recesses 4 and related lands defining the recesses 4.

Consequently, in a subsequent method step, the structure to be analyzed can be sensed by scanning beams being guided through the further trench 5 from the side of the lateral limitation 6 of the trench 5.

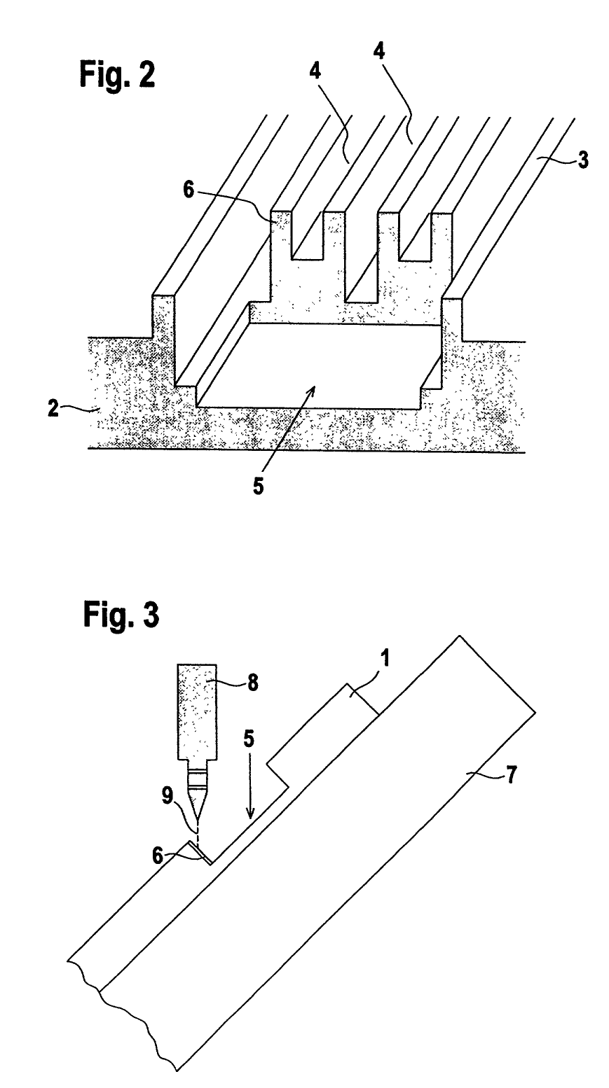

Represented in FIG. 1a with a border in broken lines is the region of the surface of the photomask 1 over which the further trench 5 extends. Likewise represented in FIG. 1b with a border in broken lines is the part of the cross-sectional surface of the photomask 1 over which the lateral limitation 6 of the further trench 5 extends. Finally, a perspective view of a detail of the further trench 5 in the photomask 1 is represented in FIG. 2.

As can be seen in particular from FIGS. 1b and 2, the lateral limitation 6 of the trench 5 which is scanned by the scanning beams runs transversely in relation to the longitudinal directions of the trench-shaped recesses 4 in the photomask 1.

In this case, a width of the further trench 5 is chosen such that a plurality of sequences of alternating recesses 4 separated by lands are exposed at the lateral limitation 6 of the trench 5 and can consequently be analyzed. In particular, it can be investigated whether the recesses 4 have in each case the desired geometries and, in particular, required depths. The depth of the further trench 5 is in this case chosen such that the trench-shaped recesses 4 are completely exposed.

The length of the further trench 5 is of the same order of magnitude as the width of the further trench 5. In this case, the dimensions of the further trench 5 are chosen in particular such that the scanning beams can pass through the further trench 5 unhindered and can completely scan the lateral limitation 6 of the further trench 5.

The depth of the further trench 5 is typically up to 1 μm. The width of the further trench 5 preferably lies in the range between 0.5 μm and 2 μm.

The further trenches 5 required for the structural analysis are expediently etched into the photomask 1. The etching process is preferably carried out by a focused ion beam. In this case, the focused ion beam is directed at the surface of the photomask 1. A device 10 outputting a focused ion beam is only schematically represented in FIG. 1a.

FIG. 3 schematically shows a device for carrying out the structural analysis according to the invention on the photomask 1.

The photomask 1 with the etched-in further trench 5 is fixed on a sample table 7 in a predetermined position. In this case, the photomask 1 lies with its underside on the sample table 7, so that the further trench 5 on the upper side of the photomask 1 is exposed.

The scanning beams are directed from above onto the trench 5. The scanning beams provided for this purpose are formed by a scanning electron microscope. Represented in FIG. 3 is a scanning head 8 of an electron microscope, from which electron beams 9 which form the scanning beams 9 are emitted.

The scanning head 8 has at its front end an opening at which the electron beams 9 emerge. The scanning head 8 is located over the upper side of the further trench 5, so that the electron beams 9 are guided over the structures to be analyzed at the lateral limitation of the further trench 5.

For the alignment of a beam axis of the electron beams 9 in relation to the structures to be analyzed, the sample table 7 is configured such that it can be positionally adjusted. In this case, an inclination of the sample table 7 in particular can be adjusted with high accuracy.

In the present exemplary embodiment, the beam axis of the electron beams 9 of the electron microscope runs essentially in a vertical direction. The sample table 7 is then preferably set to an inclination of 45°. The lateral limitation 6 of the further trench 5 running perpendicularly in relation to the surface of the photomask 1 is then likewise oriented at an angle of 45° in relation to the beam axis of the electron beams 9. With such an alignment of the photomask 1, the structure to be analyzed can be sensed completely at the lateral limitation 6 of the further trench 5.

We claim:

1. A method for analyzing parts of a mask, which comprises the steps of:
providing a photomask;
creating a trench having at least one lateral limitation in the photomask such that the lateral limitation of the trench forms a section through structures of the photomask to be analyzed; and
scanning the structures to be analyzed using scanning beams guided through the trench onto the lateral limitation.

2. The method according to claim 1, which comprises forming the trench at reference positions of the photomask which are not required for a functioning of the photomask.

3. The method according to claim 1, which comprises forming the scanning beams from electron beams output from a scanning electron microscope.

4. The method according to claim 2, which comprises etching the photomask for forming the trench.

5. The method according to claim 4, which comprises using a focused ion beam during the etching step.

6. The method according to claim 1, which comprises creating the trench with a depth of up to 1 μm using a focused ion beam.

7. The method according to claim 5, which comprises creating the trench with a width in a range of 0.5 μm to 2 μm using the focused ion beam.

8. The method according to claim 1, which comprises fixing the photomask to a sample table and aligning the photomask by a positional adjustment of the sample table with respect to the scanning beams after the step of creating the trench in the photomask.

9. The method according to claim 8, which comprises adjusting an inclination of the sample table for aligning the photomask with respect to the scanning beams.

10. The method according to claim 9, which comprises setting an angle of inclination of a surface of the sample table in relation to a beam axis of the scanning beams to approximately 45°.

11. The method according to claim 1, which comprises forming the lateral limitation of a sectional face to run transversely in relation to the structures to be analyzed.

12. The method according to claim 1, which comprises forming the structures to be analyzed as trench-shaped recesses etched out of a surface of the photomask.

13. The method according to claim 1, which comprises providing the photomask as a basic body containing quartz glass.

14. The method according to claim 13, which comprises applying absorber films to a surface of the quartz glass.

15. A device, comprising:
first means for creating at least one trench in a photomask, the trench having at least one lateral limitation forming a section through structures to be analyzed; and
second means for scanning the structures to be analyzed, said second means for scanning emitting scanning beams guided through the trench onto said lateral limitation.

16. The device according to claim 15, including third means for aligning the trench of the photomask with respect to a beam direction of the scanning beams.

17. The device according to claim 15, wherein said first means for creating the trench in the photomask includes an ion beam device outputting a focused ion beam.

18. The device according to claim 15, wherein said second means for scanning the structures to be analyzed includes a scanning electron microscope.

19. The device according to claim 15, wherein said third means for aligning the trench of the photomask includes a positionally adjustable sample table on which the photomask can be fixed.

20. A device, comprising:
an ion beam device outputting a focused ion beam for creating at least one trench in a photomask, the trench having at least one lateral limitation forming a section through structures to be analyzed; and
a scanning electron microscope for scanning the structures to be analyzed, said scanning electron microscope emitting scanning beams guided through the trench onto said lateral limitation.
